(19) United States
(12) Patent Application Publication
(10) Pub. No.: US 2025/0156945 A1
(43) Pub. Date: May 15, 2025

(54) SYSTEM AND METHOD FOR MANAGING SUPPLY CHAIN AND RETAIL FINANCE

(71) Applicant: VENKATAKRISHNAN GURUPRASAD, ERODE (IN)

(72) Inventor: VENKATAKRISHNAN GURUPRASAD, ERODE (IN)

(21) Appl. No.: 18/835,473

(22) PCT Filed: Apr. 6, 2022
(86) PCT No.: PCT/IB2022/053203

§ 371 Date: Aug. 2, 2024

(30) Foreign Application Priority Data
Feb. 7, 2022 (IN) 202241006518
Apr. 6, 2022 (WO) PCT/IB2022/053203

(51) Int. Cl. G06Q 40/03; G06Q 10/087; G06Q 30/0601

(52) U.S. Cl. CPC G06Q 40/03; G06Q 10/087; G06Q 30/0633

(57) ABSTRACT

A system for managing supply chain finance is disclosed. A finance request receiving module 110 receives one or more invoices corresponding to one or more supplied goods or one or more provided services from a supplier, receives a request for process of raising funds from a buyer. A financier seeking module 120 identifies a financier for financing the funds to the buyer. A supply chain financing module 130 generates a perpetual contract between the buyer and the financier for financing the funds, enables the financier in financing the funds with one or more currencies to the buyer for paying the supplier for each of the one or more supplied goods or the one or more provided services, enable the buyer to repay the funds to the financier with interest using the one or more currencies based on the perpetual contract generated for managing the supply chain finance.

### EARLIEST PRIORITY DATE

This Application claims priority from a patent application filed in India having Patent Application No. 202241006518, filed on Feb. 7, 2022 and titled “SYSTEM AND METHOD FOR MANAGING SUPPLY CHAIN AND RETAIL FINANCE” and a PCT Application no. PCT/IB2022/053203 filed on Apr. 6, 2022, and titled “SYSTEM AND METHOD FOR MANAGING SUPPLY CHAIN AND RETAIL FINANCE”

### BACKGROUND

Embodiments of the present disclosure relate to a trade finance system and more particularly to a system and a method for managing supply chain and related to lending, borrowing, saving and interest rate block chain and finance protocols of retail finance.

Trade transactions can involve the sale of goods or services from a seller to a buyer. Financial intermediaries such as banks and other financial institutions can facilitate these transactions by financing the trade. Generally, small and medium sized enterprises (SMEs) are often in need of short-term financing the trade especially when there is a sudden and immediate need for increased working capital to fund wages or the purchase of raw materials. Such SMEs will very often take out short-term loans from their bank or from newer, more innovative P2P (peer-to-peer) invoice finance platforms that have recently entered the industry. As a result, in order to help the seller and the buyer of such SMEs, supply chain finance (SCF) as a solution is utilised in various sectors to lower financing costs and improve business efficiency for the buyer and the seller linked in a sales transaction. Crypto trading players would avail loan with the lending protocols by pledging the collaterals in the form of crypto assets viz., Bitcoin, Ethereum, Solana, Polygon etc., to avail loans. This network would be helpful to mitigate the risk of volatility and the costs involved in the liquidation of their collateralized assets.

Conventionally, the P2P invoice finance platforms which are available to provide the finance operates by providing short term liquidity on invoices for short durations of up to approximately from 15 days to 180 days. Also, rather than waiting for their customers to settle invoices that have due dates of approximately 45 to 90 days, a SME may sell their invoices to the P2P invoice financing platforms to access immediate funds. However, the conventional P2P invoice financing platforms are vulnerable to fraud, and in particular duplication in the selling of invoices which is difficult to mitigate. In addition, the P2P platforms are unique in a way, that they connect invoice sellers directly with invoice buyers making the rise of P2P as an alternative lending platform and more attractive to businesses globally. The invoices scanned using scanners are made as Non-Fungible Tokens to deal on chain in block chain network. One of the most prominent and painful inefficiencies in those DeFi protocols is liquidation. Despite providing 150% of the asset as security traders/borrowers/investors can't escape the risks of volatility. Let's say for example, $150 bitcoin has been posted for $100 of stable coins (USDC, USDT, BUSD, DAI. These are few stable coins) Let's say in the afternoon, the value of Bitcoin reaches $125, the network would ask to post $25 additional value of Bitcoin to make it 150% to 100%. And traders are posting $25 and again in the evening its value is again dropping to $125 repetition has to be done and assume that traders are doing and in the night if the value reaches to $101/$102 instantly due to volatility for a sec, whole bitcoin position would be liquidated even in the next second if the value jumped to $200 it's of no use to the borrower or traders who act as borrowers in this protocol by pledging their crypto assets for the purpose of doing trading or investment in crypto assets. Traders would end up losing more than $200 worth of bitcoin that includes additional $50 posted to maintain margin requirements. In order to solve the liquidation problem a bitcoin perpetual/futures contract would be entered during the time of borrowing of stable coins. Let's say in the same above example a futures/perpetual contract is entered for $150 in bitcoin to mitigate the bitcoin currency volatility risk. In this above case, to protect the downside risk contract has to be sold. Based on the cases, perpetual/futures contract would get bought or sold to mitigate the currency volatility risk. Any downside would get protected and borrower collateral value of $150 would get protected during tenure of the loan period.

Hence, there is a need for an improved system and a method for managing supply chain and retail finance in order to address the aforementioned issues.

### BRIEF DESCRIPTION

In accordance with an embodiment of a present disclosure, a system for managing supply chain finance is disclosed. The system includes a processing subsystem hosted on a server and configured to execute on a network to control bidirectional communications among a plurality of modules. The processing subsystem includes a finance request receiving module configured to receive one or more invoices corresponding to one or more supplied goods or one or more provided services from a supplier. The invoices generated are scanned using scanners and are made as a non-fungible tokens to deal on-chain in blockchain system. The finance request receiving module is also configured to receive a request for process of raising funds from a buyer for the one or more supplied goods or the one or more provided services based on the one or more invoices received from the supplier. The processing subsystem also includes a financier seeking module configured to identify a financier for financing the funds to the buyer based on the request received, wherein the funds corresponding to each of the one or more supplied goods or the one or more provided services is raised by the supplier. The processing subsystem also includes a supply chain financing module configured to generate a perpetual contract to mitigate the volatility of currencies that are used for lending between the buyer and the financier for financing the funds upon identification of the financier. The supply chain financing module is configured to enable the financier in financing the funds with one or more currencies to the buyer for paying the supplier for each of the one or more supplied goods or the one or more provided services based on the perpetual contract generated. The supply chain financing module is also configured to enable the buyer to repay the funds to the financier with interest using the one or more currencies based on the perpetual contract generated for managing the supply chain finance.

In accordance with another embodiment of a present disclosure, a system for managing retail finance is disclosed. The system includes a retail processing subsystem which includes a retail finance request receiving module to receive one or more cryptocurrencies or assets as a collateral from the borrower. The processing subsystem also includes the financier seeking module configured to identify the financier for financing the funds to the borrower based on the request received. The processing subsystem also includes a retail financing module configured to generate perpetual contracts to mitigate volatility risk between the borrower and financier. The retail finance module is configured to enable the financier in financing the funds with one or more currencies to the buyer for paying the supplier for each of the one or more collateral assets provided based on which perpetual contracts get generated. Retail finance module is also configured to enable borrower to repay the funds to the financier with interest using one of more currencies based on perpetual contract generated for managing the volatility risk involved in retail finance on the collateralized assets.

In accordance with another embodiment, of the present disclosure, a method for managing supply chain finance is disclosed. The method includes receiving, by a finance request receiving module of a processing subsystem, one or more invoices corresponding to one or more supplied goods or one or more provided services from a supplier. The method also includes receiving, by the finance request receiving module of the processing subsystem, a request for process of raising funds from a buyer for the one or more supplied goods or the one or more provided services based on the one or more invoices received from the supplier. The method also includes identifying, by a financier seeking module of the processing subsystem, a financier for financing the funds to the buyer based on the request received, wherein the funds corresponding to each of the one or more supplied goods, or the one or more provided services is raised by the supplier. The method also includes generating, by a supply chain financing module of the processing subsystem, a perpetual contract between the buyer and the financier for financing the funds upon identification of the financier. The method also includes enabling, by the supply chain financing module of the processing subsystem, the financier in financing the funds with one or more currencies to the buyer for paying the supplier for each of the one or more supplied goods or the one or more provided services based on the perpetual contract generated. The method also includes enabling, by the supply chain financing module of the processing subsystem, the buyer to repay the funds to the financier with interest using the one or more currencies based on the perpetual contract generated for managing the supply chain finance.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for managing supply chain finance in accordance with an embodiment of the present disclosure;

FIG. 2 is a schematic representation of an exemplary embodiment of a system for managing supply chain finance of FIG. 1 in accordance with an embodiment of the present disclosure;

FIG. 3 is a block diagram of a computer or a server in accordance with an embodiment of the present disclosure;

FIG. 4 is an embodiment of a block diagram of a system for managing retail finance in accordance with an embodiment of the present disclosure;

FIG. 5 is a schematic representation of an exemplary embodiment of a system for managing retail finance of FIG. 4 in accordance with an embodiment of the present disclosure;

FIG. 6 is a flow chart representing the steps involved in a method for managing supply chain finance of FIG. 1 in accordance with an embodiment of the present disclosure; and

FIG. 7 is a flow chart representing the steps involved in a method for managing retail finance of FIG. 4 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for managing supply chain and retail finance. The system includes a processing subsystem hosted on a server and configured to execute on a network to control bidirectional communications among a plurality of modules. The processing subsystem includes a finance request receiving module configured to receive one or more invoices corresponding to one or more supplied goods or one or more provided services from a supplier. The finance request receiving module is also configured to receive a request for the process of raising funds from a buyer for the one or more supplied goods or the one or more provided services based on the one or more invoices received from the supplier. The processing subsystem also includes a financier seeking module configured to identify a financier for financing the funds to the buyer based on the request received, wherein the funds corresponding to each of the one or more supplied goods or the one or more provided services is raised by the supplier. The processing subsystem also includes a supply chain financing module configured to generate a perpetual contract between the buyer and the financier for financing the funds upon identification of the financier. The supply chain financing module is configured to enable the financier in financing the funds with one or more currencies to the buyer for paying the supplier for each of the one or more supplied goods or the one or more provided services based on the perpetual contract generated. The supply chain financing module is also configured to enable the buyer to repay the funds to the financier with interest using the one or more currencies based on the perpetual contract generated for managing the supply chain finance.

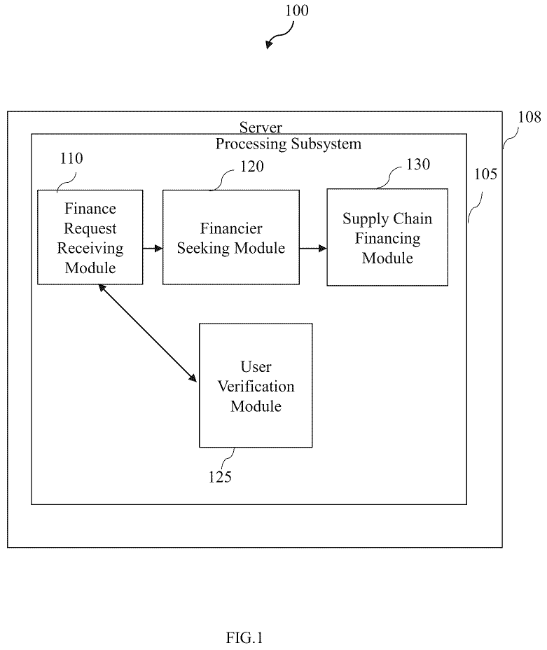

FIG. 1 is a block diagram of a system 100 for managing supply chain finance in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like. In a specific embodiment, the processing subsystem 105 may include a blockchain based platform for managing trading of supply chain finance.

The processing subsystem 105 includes a finance request receiving module 110 configured to receive one or more invoices corresponding to one or more supplied goods or one or more provided services from a supplier. In one embodiment, the one or more invoices received from the supplier are scanned using scanners. The finance request receiving module 110 is also configured to receive a request for process of raising funds from a buyer for the one or more supplied goods or the one or more provided services based on the one or more invoices received from the supplier.

In a specific embodiment, the processing subsystem 105 further includes a user verification module 125 configured to verify the supplier for obtaining the funds using a know your customer (KYC) verification process. The KYC process helps in credit checking for the user. If the credit score is lower than 700, then such a user is rejected. Similarly, if the credit score of the user is higher than 700, then its accepted. The KYC process begins once a registered user such as the supplier logs in into the system with a corresponding username and password. Alternatively, another option for providing funds for SCF could also be considered. The parameters for Credit score and percentages of Funds provided for SCF are listed on scores. Credit scores below 600=40% funds 600-650=50%; 650-700=65%; 700 above=More than 75%-100%. All are at the discretion of the lender. Retail Finance protocols deals with fully collateralized lending/investing/borrowing and hence are designed to be permission-less protocols. Even if it's centralized system, collateralized crypto assets wouldn't require the credit scores as lending/borrowing/investing is secured by crypto or assets collaterals.

The processing subsystem 105 also includes a financier seeking module 120 configured to identify a financier for financing the funds to the buyer based on the request received, wherein the funds corresponding to each of the one or more supplied goods or the one or more provided services is raised by the supplier. In one embodiment, the financier may include at least one of a lending financial institution, a person or a combination thereof.

The processing subsystem 105 also includes a supply chain financing module 130 configured to generate a perpetual contract for mitigation of currencies volatility risk between the buyer and the financier for financing the funds upon identification of the financier. As used herein, the term ‘perpetual contract’ is defined as a derivative financial contract that has no expiration date or settlement, allowing it to be held or traded for an indefinite amount of time.

The supply chain financing module 130 is configured to enable the financier in financing the funds with one or more currencies to the buyer for paying the supplier for each of the one or more supplied goods or the one or more provided services based on the perpetual contract generated. In some embodiment, the one or more currencies may include a cryptocurrency and a fiat currency. In such embodiment, the cryptocurrency may include at least one of a Bitcoin, an Ethereum, a dogecoin or a combination thereof. Repayments are made either with the Fiat or the one or more cryptocurrencies. An agreement must be entered with crypto companies for the settlement of loans. There are two options, one is paying it back with Fiat plus interest and other is through cryptocurrencies with interest also with the one or more cryptocurrencies. Further, the best way to mitigate risk is to enter into the perpetual contracts of the coins that have been borrowed as loan. These perpetual contracts don't have expiry and are traded using leverage. In a specific embodiment, the supply chain financing module 130 is configured to receive one or more inputs associated with repayment process of the funds from the buyer, wherein the one or more inputs includes a decision associated with depositing the funds using fiat currency, a decision associated with depositing the funds using cryptocurrency, a decision associated with depositing the funds using fungible tokens, a risk mitigation strategy and convenient way to do payback. As used herein, the term ‘fungible token’ is defined as alternate way to come out with the payment where investors could subscribe to the tokens released by the company. Basically, the fungible tokens are having ample supply and are made to use it as native token of the network to maintain stability and to ease use in the network so that repayment won't be an issue. If volatility is minimized substantially funding through cryptocurrencies could be achieved. The stable currencies is to fund the finances that are required for the supply chain finance and also working with crypto companies and crypto ecosystem and also coming out with fungible tokens would be helpful to solve the issue.

The supply chain financing module 130 is also configured to enable the buyer to repay the funds to the financier with interest using the one or more currencies based on the perpetual contract generated for managing the supply chain finance (SCF). As used herein, the term ‘supply chain finance’ is defined as a set of business and financing practices that form the connections between various parties in a transaction buyer, seller and financing institution in order to lower financing costs and improve business efficiency. Under this paradigm, the buyers agree to approve their supplier's invoices for financing by the financial institution such as bank or another outside financier. By providing a short-term credit, optimizes working capital and provides liquidity to both parties. The SCF offers distinct advantages to all participants. While suppliers gain quicker access to money they are owed, the buyers get more time to pay off their balances. On either side of the equation, the parties can use the cash on hand for other projects to keep their respective operations running smoothly.

In a particular embodiment, multiple types of trading services offered under the SCF may include, but not limited to, export and import bills for collections, export letter of credit advising, import and invoice financing, letter of credit checking, negotiation, confirmation and safekeeping, performance bonds, pre-shipment export finance, inventory finance, purchase order, finances against goods and the like. In a particular embodiment, multiple types of trading services offered under the RF may include, but not limited to lending, borrowing, investing in crypto related assets.

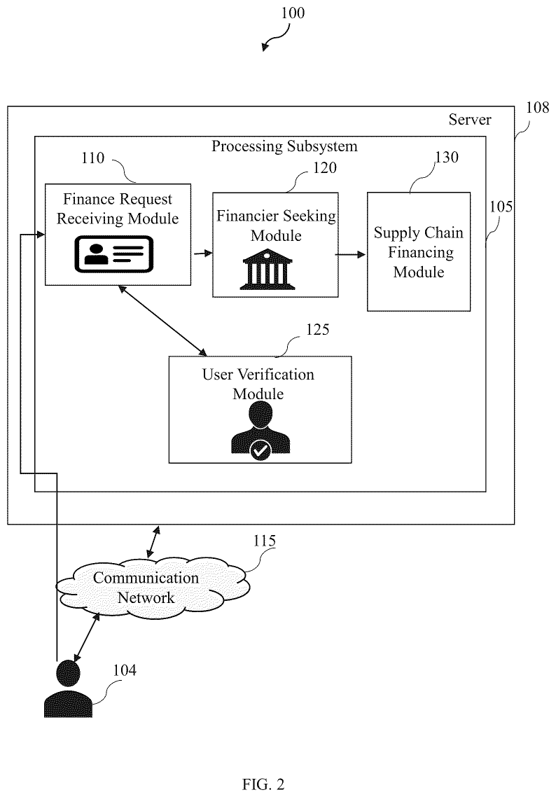

FIG. 2 is a schematic representation of an exemplary embodiment of a system for managing supply chain finance of FIG. 1 in accordance with an embodiment of the present disclosure. Considering an example, wherein the system 100 is utilised in a transportation industry. In the example used herein, let's assume a person A 104, who is a driver, is in business of doing transportation and involved in borrowing money to buy a truck and use it as a truck service provider to make money. In such a scenario, let's assume that he doesn't have enough money for outright purchase, and he is going to a financial institution to avail credit facility for purchasing the truck.

For obtaining the credit facility, all these processes take place through our medium that could have multiple touch points, including offline brick-n-mortar OR call centre based and/or on digital mode like internet and mobile and or combination of all. For example, the Person A could be male, female or transgender.

In a specific embodiment, the processing subsystem 105 further includes a user verification module 115 configured to verify the user for obtaining the funds using a know your customer (KYC) verification process. The KYC process helps in credit checking for the user. If credit score is lower than 700, then such user is rejected. Similarly, if credit score of the user is higher than 700, then its accepted. Alternatively, another option for providing funds for SCF could also be considered. The parameters for Credit score and percentages of Funds provided for SCF are listed based on scores. Credit scores below 600=40% funds 600-650=50%; 650-700=65%; 700 above=More than 75%-100%. All are at the discretion of the lender. The KYC process begins once a registered user such as the supplier logs in into the system with a corresponding username and password. In a specific embodiment, the processing subsystem 1005 further includes a user verification module 1115 configured to verify the user for obtaining the funds using a know your customer (KYC) verification process. Alternatively, this system could also work without KYC process by being permission less system. Permission less system works only with code and retail finance is available with collaterals and as such, there is no specific necessity to know the credit score of the borrower.

Further, in order to receive the loan request for purchasing the truck, a financial request receiving module 110 of a processing subsystem 105, receives one or more invoices corresponding to one or more supplied goods or one or more provided services. The financial request receiving module 110 also receives a request for process of raising funds from a buyer for the one or more supplied goods or the one or more provided services based on the one or more invoices received. In such an example, the processing subsystem is hosted on a cloud server 108 and executes on a wireless communication network 115 to control bidirectional communications among a plurality of modules.

Once, the process of requesting funds is received, a financier seeking module 120 identifies a financier for financing the funds to the buyer based on the request received, wherein the funds corresponding to each of the one or more supplied goods, or the one or more provided services is raised by the supplier. Here, the Person A sends an application for finding a suitable financial institution. Upon receiving the application, the financier seeking module sends it to multiple lending institutions for finding the feasibility. Upon finding the feasibility it matches with Institution A that agrees to lend to person A to provide loan under the option of with or without depositing margin money and is giving the option to payback under different available payback terms. After that, the Person A chooses his convenient option and enters into a contract.

A supply chain finance financing module 130 generates a perpetual contract to mitigate the currency volatility risk between the buyer and the financier for financing the funds upon identification of the financier. Also, the supply chain financing module 130 enables the financier in financing the funds with one or more currencies to the buyer for paying the supplier for each of the one or more supplied goods or the one or more provided services based on the perpetual contract generated. In the example used herein, the one or more currencies may include a cryptocurrency and a fiat currency. In such an example, the cryptocurrency may include at least one of a Bitcoin, an Ethereum, a Dogecoin or a combination thereof.

Further, the supply chain financing module 130 enables the buyer to repay the funds to the financier with interest using the one or more currencies based on the perpetual contract generated to mitigate the currency volatility risk for managing the supply chain finance (SCF). Money or funds lent by the financial institution and funds paid back by the person A and funds received by the vendor who receives money or funds from the financial institution on behalf of the Person A 104 and the like, all such things happen through this integrated block-chain based trading platform for the transaction which would complete the process of procuring products/services and or combination of both between various parties involved in this perpetual contract. Again, the options of payback for the repayment process may include, but not limited to, daily basis in which the loan could be paid back on a daily basis based on his daily cash flow, weekly basis in which loan could be paid back on weekly basis, monthly basis in which loan could be paid back on monthly basis, annual basis in which loan could be paid back on annual basis and the like. Thus, the system 100 helps in solving funding gaps of SMEs and micro-enterprises with cryptocurrencies and thereby solves the funding requirements for working capital.

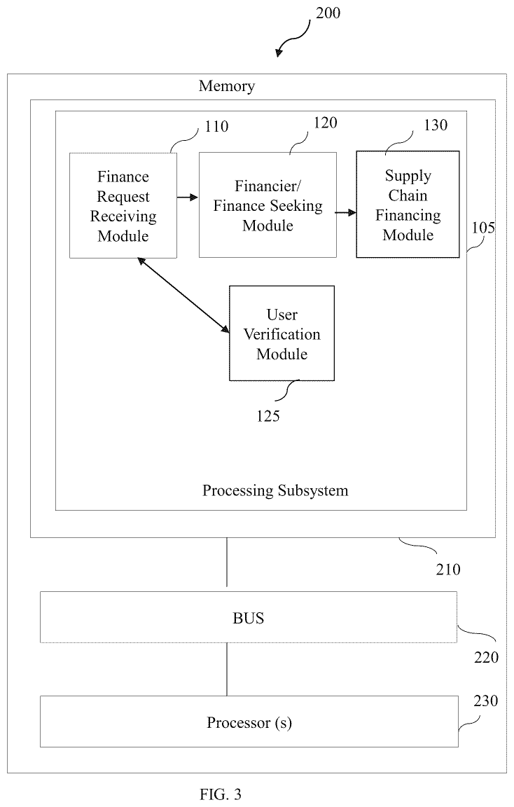

FIG. 3 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a finance requesting receiving module 110, a financier seeking module 120, a supply chain financing module 130 and a user verification module 115.

The finance request receiving module 110 is configured to receive one or more invoices corresponding to one or more supplied goods or one or more provided services from a supplier. The finance request receiving module 110 is also configured to receive a request for process of raising funds from a buyer for the one or more supplied goods or the one or more provided services based on the one or more invoices received from the supplier. The user verification module 115 is configured to verify the supplier for obtaining the funds using a know your customer verification process. The financier seeking module 120 is configured to identify a financier for financing the funds to the buyer based on the request received, wherein the funds corresponding to each of the one or more supplied goods or the one or more provided services is raised by the supplier. The supply chain financing module 130 is configured to generate a perpetual contract between the buyer and the financier for financing the funds upon identification of the financier. The supply chain financing module 130 is configured to enable the financier in financing the funds with one or more currencies to the buyer for paying the supplier for each of the one or more supplied goods or the one or more provided services based on the perpetual contract generated. The supply chain financing module 130 is also configured to enable the buyer to repay the funds to the financier with interest using the one or more currencies based on the perpetual contract generated for managing the supply chain finance.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

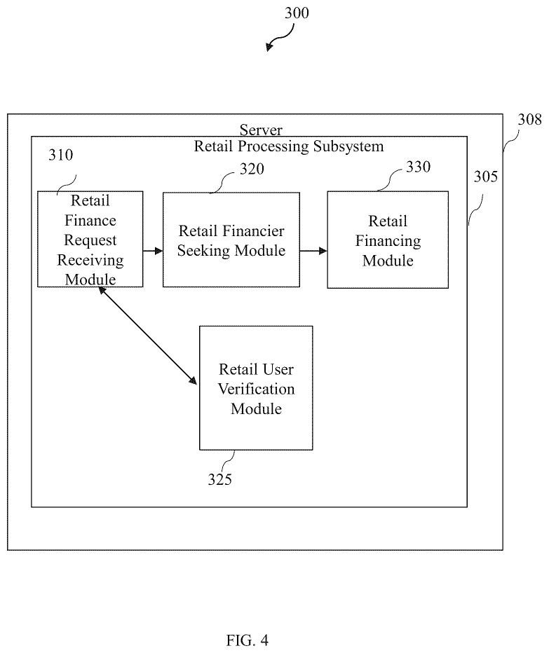

FIG. 4 is a block diagram of an embodiment of a system 300 for managing retail finance in accordance with an embodiment of the present disclosure. The system 300 includes a retail processing subsystem 305 hosted on a server 308. In one embodiment, the server 308 may include a cloud server. In another embodiment, the server 308 may include a local server. The retail processing subsystem 305 is configured to execute on a network (not shown in FIG. 4) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like. In a specific embodiment, the processing subsystem 1005 may include a blockchain based platform for managing trading of retail finance.

The retail processing subsystem 305 includes a retail finance request receiving module 310 configured to receive one or more collateralized requests corresponding to one or more collaterized crypto assets or one or more collateral requests from a borrower. The retail finance request receiving module 310 is also configured to receive a request for the process of raising funds from a borrower for the one or more collateral borrowing requests based on the one or more collateralized crypto assets received from the borrowers.

The retail processing subsystem 305 also includes a retail financier seeking module 320 configured to identify a financier for financing the funds to the borrower based on the request received, wherein the funds corresponding to each of the one or more collateralized crypto assets or the one or more collateral based borrowing requests raised by the borrower. In one embodiment, the financier may include at least one of a lending financial institution, a person or a combination thereof.

The retail processing subsystem 305 also includes a retail financing module 330 configured to generate a perpetual contract for mitigation of currencies volatility risk between the borrower and the financier for financing the funds upon identification of the financier. The retail financing module 330 is configured to enable the financier in financing the funds with one or more currencies to the borrower for paying the borrowing requests for each of the one or more collateral crypto assets or the one or more provided collateralized borrowing request based on the perpetual contract generated. In some embodiment, the one or more currencies may include a cryptocurrency and a fiat currency. In such embodiment, the cryptocurrency may include at least one of a Bitcoin, an Ethereum, a dogecoin or a combination thereof. Repayments are made either with the Fiat or the one or more cryptocurrencies. An agreement must be entered with crypto companies and crypto ecosystem for the settlement of loans. There are two options, one is paying it back with Fiat plus interest and other is through cryptocurrencies with interest also with the one or more cryptocurrencies. Further, the best way to mitigate risk is to enter into the perpetual contracts of the coins that have been borrowed as loan. These perpetual contracts don't have expiry and are traded using leverage. In a specific embodiment, the retail financing module 330 is configured to receive one or more inputs associated with repayment process of the funds from the borrower, wherein the one or more inputs includes a decision associated with depositing the funds using fiat currency, a decision associated with depositing the funds using cryptocurrency, a decision associated with depositing the funds using fungible tokens, a risk mitigation strategy and a convenient way to do payback. As used herein, the term ‘fungible token’ is defined as alternate way to come out with fungible tokens where investors could subscribe to the tokens released by the company. Basically, the fungible tokens are having ample supply and made to use as a native token of the network to maintain stability and to ease use in the network so that repayment won't be an issue. If volatility is minimized substantially funding through cryptocurrencies could be achieved. The stable currencies is to fund the finances that are required for the retail finance and also working with crypto companies and crypto ecosystem and also coming out with fungible tokens would be helpful to solve the issue.

The retail financing module 330 is also configured to enable the borrower to repay the funds to the financier with interest using the one or more currencies based on the perpetual contract generated for managing the currency volatility risk in retail finance. As used herein, the term ‘retail finance’ is defined as a set of business and financing practices that form the connections between various parties in a transaction borrower, lender, investor, financier and financing institution in order to lower financing costs and improve business efficiency. Under this paradigm, the borrowers agree to post collateral of their crypto assets for financing by the financial institution such as crypto lending protocols or another outside financier. By providing a short-term credit, optimizes short term personal finances and provides liquidity to both parties. The Retail Finance (RF) offers distinct advantages to all participants. While financiers or lenders gain quicker access to crypto assets for the stable currencies they are owed, the borrowers get more time to pay off their balances. On either side of the equation, the parties can use the cash on hand for other personal finances to keep their respective operations running smoothly.

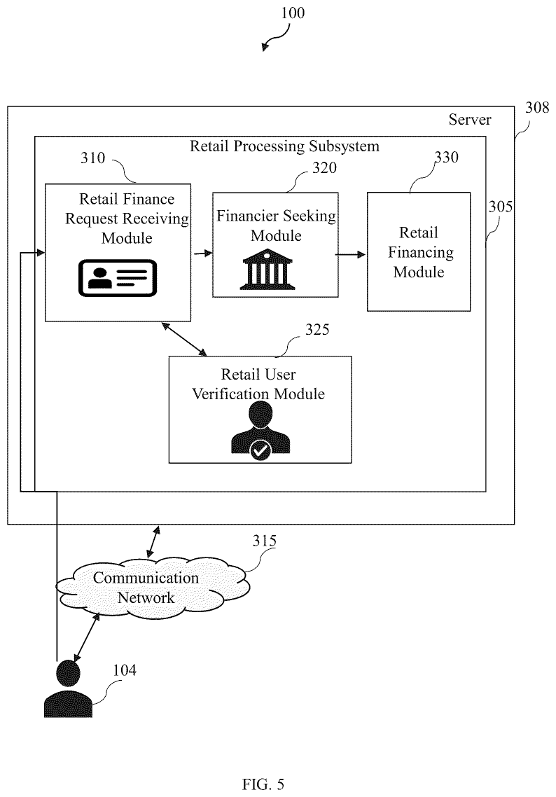

FIG. 5 is a schematic representation of an exemplary embodiment of a system for managing retail finance of FIG. 4 in accordance with an embodiment of the present disclosure. Considering an example, wherein the system 300 is utilised in a retail crypto trading industry. In the example used herein, let's assume a person A 304, who is a trader is in the business of doing trading and involved in borrowing money to trade crypto currencies/assets and to make money. In such a scenario, let's assume that he doesn't have enough money for outright trading, and he is going to a crypto lending protocol to avail credit facility for his crypto assets.

Further, in order to receive the loan request for the purpose of trading, a retail financial request receiving module 310 of a retail processing subsystem 3005, receives one or more borrowing requests corresponding to one or more crypto asset collaterals or one or more crypto collateralized assets. The retail financial request receiving module 310 also receives a request for process of raising funds from a borrower for the one or more crypto collaterals or the one or more borrowing requests based on the one or more crypto collaterals received. In such an example, the processing subsystem is hosted on a cloud server 308 and executes on a wireless communication network 315 to control bidirectional communications among a plurality of modules.

Once, the process of requesting funds is received, the retail financier seeking module 320 identifies a financier for financing the funds to the borrower based on the request received, wherein the funds corresponding to each of the one or more crypto assets, or the one or more collaterized assets is posted as collateral by the borrower. Here, the Borrower A sends an application for finding a suitable source to finance against the collaterals. Upon receiving the application, the financier seeking module sends it to multiple lending institutions for finding the feasibility. Upon finding the feasibility it matches with Institution A that agrees to lend to Borrower A to provide loan under the option of crypto assets that are collateralized or provided as collateral and is giving the option to payback under different available payback terms. After that, the Person A chooses his convenient option and enters into a contract.

A retail financing module 3300 generates a perpetual contract to mitigate the currency volatility risk between the buyer and the financier for financing the funds upon identification of the financier. Also, the retail financing module 1300 enables the financier in financing the funds with one or more currencies to the buyer for paying the borrower for each of the one or more crypto assets or the one or more collateralized assets based on the perpetual contract generated. In the example used herein, the one or more currencies may include a cryptocurrency and a stable crypto currency. In such an example, the cryptocurrency may include at least one of a Bitcoin, an Ethereum, a Dogecoin, Tether, or a combination thereof.

Further, the retail financing module 330 enables the borrower to repay the funds to the financier with interest using the one or more currencies based on the perpetual contract generated to mitigate the currency volatility risk for managing the retail finance (RF). Money or funds lent by the financial institution and funds paid back by the Borrower A and funds received by the lender or financier who receives money or funds from the financial institution on behalf of the Borrower A 1004 and the like, all such things happen through this integrated block-chain based trading platform for the transaction which would complete the process of crypto collateral, collateralized assets and or combination of both between various parties involved in this perpetual contract for mitigation of risk. Again, the options of payback for the repayment process may include, but not limited to, daily basis in which the loan could be paid back on a daily basis based on his daily cash flow, weekly basis in which loan could be paid back on weekly basis, monthly basis in which loan could be paid back on monthly basis, annual basis in which loan could be paid back on annual basis and the like. Thus, the system 1000 helps in solving liquidation problems of lending protocols and avoid the liquidation of crypto assets with cryptocurrencies and thereby solves the funding requirements for trading crypto currencies and crypto assets.

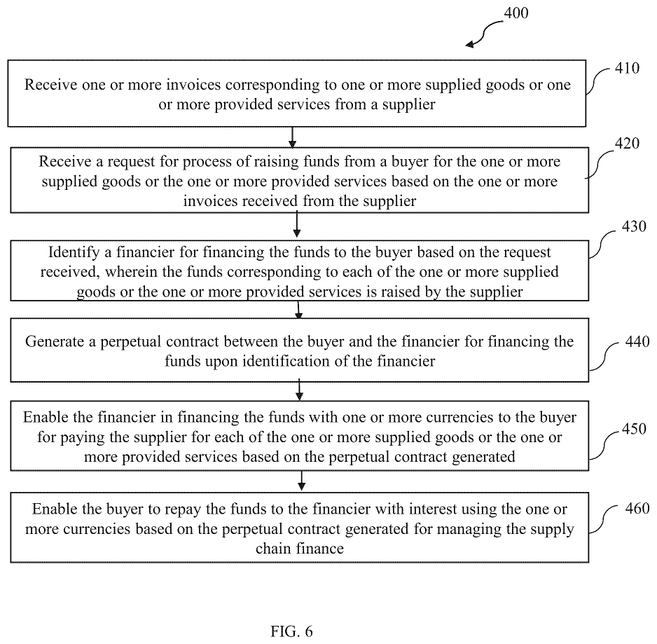

FIG. 6 is a flow chart representing the steps involved in a method 400 for managing supply chain finance of FIG. 1 in accordance with an embodiment of the present disclosure. The method 400 includes receiving, by a finance request receiving module of a processing subsystem, one or more invoices corresponding to one or more supplied goods or one or more provided services from a supplier in step 410. In one embodiment, receiving the one or more invoices corresponding to each of the one or more supplied goods or one or more provided services may include receiving the one or more invoices received from the supplier upon scanning using scanners. The method 400 also includes receiving, by the finance request receiving module of the processing subsystem, a request for process of raising funds from a buyer for the one or more supplied goods or the one or more provided services based on the one or more invoices received from the supplier in step 420.

The method 400 also includes identifying, by a financier seeking module of the processing subsystem, a financier for financing the funds to the buyer based on the request received, wherein the funds corresponding to each of the one or more supplied goods or the one or more provided services is raised by the supplier in step 430. In some embodiment, identifying the financier for financing the funds to the buyer may include identifying at least one of a lending financial institution, a person or a combination thereof.

The method 400 also includes generating, by a supply chain financing module of the processing subsystem, a perpetual contract to mitigate currency volatility risk between the buyer and the financier for financing the funds upon identification of the financier in step 440. In one embodiment, generating the perpetual contract between the buyer and the financier may include generating a derivative financial contract that has no expiration date or settlement, allowing it to be held or traded for an indefinite amount of time.

The method 400 also includes enabling, by the supply chain financing module of the processing subsystem, the financier in financing the funds with one or more currencies to the buyer for paying the supplier for each of the one or more supplied goods or the one or more provided services based on the perpetual contract generated in step 450. In some embodiment, enabling the financier in financing the funds with the one or more currencies to the buyer may include enabling the financier in financing the funds with the one or more currencies including a cryptocurrency and a fiat currency. In such embodiment, the cryptocurrency may include at least one of a Bitcoin, an Ethereum, a dogecoin or a combination thereof.

The method 400 also includes enabling, by the supply chain financing module of the processing subsystem, the buyer to repay the funds to the financier with interest using the one or more currencies based on the perpetual contract generated for managing the supply chain finance in step 460. In some embodiment, enabling the buyer to repay the funds to the financier with interest using the one or more currencies may include enabling the buyer to repay the funds using two options, such as one is paying it back with Fiat plus interest and other is through cryptocurrencies with interest also with the one or more cryptocurrencies.

In a specific embodiment, the method 400 further includes receiving by the supply chain finance module, one or more inputs associated with repayment process of the funds from the buyer, wherein the one or more inputs includes a decision associated with depositing the funds using fiat currency, a decision associated with depositing the funds using cryptocurrency, a decision associated with depositing the funds using fungible tokens, a risk mitigation strategy and payback terms. In one embodiment, receiving the one or more inputs associated with the repayment process of the funds from the buyer may include receiving the one or more inputs with a decision associated with depositing the funds using the fungible tokens as an alternate way to make payments and transact in the network where investors could subscribe to the tokens released by the company.

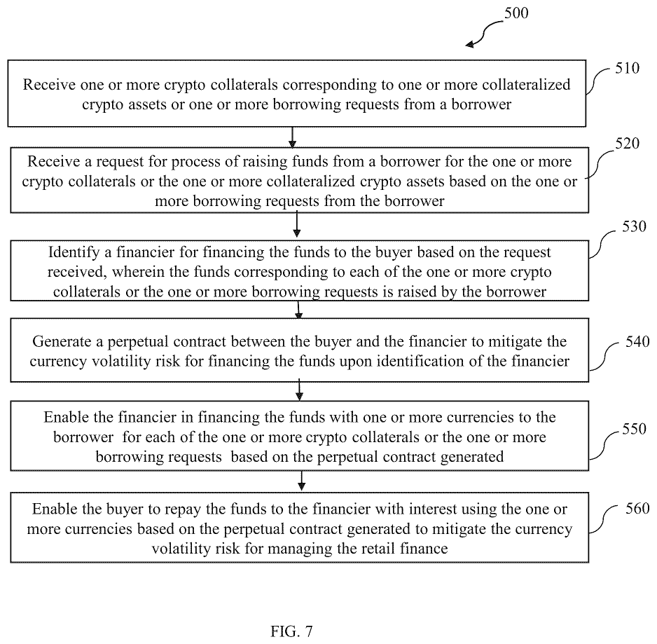

FIG. 7 is a flow chart representing the steps involved in a method 500 for managing retail finance of FIG. 4 in accordance with an embodiment of the present disclosure. The method 500 includes receiving, by a finance request receiving module of a processing subsystem, one or more borrowing requests corresponding to one or more crypto collaterals or one or more collateralized assets from a borrower in step 510. The method 500 also includes receiving, by the finance request receiving module of the processing subsystem, a request for process of raising funds from a borrower for the one or more crypto collaterals or the one or more collateralized crypto based on the one or more borrowing requests received from the borrower in step 520.

The method 500 also includes identifying, by a financier seeking module of the processing subsystem, a financier for financing the funds to the borrower based on the request received, wherein the funds corresponding to each of the one or more crypto collaterals or the one or more collateralized crypto is raised by the borrower in step 530. In some embodiment, identifying the financier for financing the funds to the borrower may include identifying at least one of a lender, lending financial institution, a person or a combination thereof.

The method 500 also includes generating, by a retail financing module of the processing subsystem, a perpetual contract to mitigate the currency volatility risk to avoid liquidations between the borrower and the financier for financing the funds upon identification of the financier in step 540.

The method 500 also includes enabling, by the retail financing module of the processing subsystem, the financier in financing the funds with one or more currencies to the borrower for paying the borrower for each of the one or more crypto collaterals or the one or more collateralized crypto assets based on the perpetual contract generated in step 550. In some embodiment, enabling the financier in financing the funds with the one or more currencies to the buyer may include enabling the financier in financing the funds with the one or more currencies including a cryptocurrency and stable currency. In such embodiment, the cryptocurrency may include at least one of a Bitcoin, an Ethereum, a Dogecoin or a combination thereof.

The method 500 also includes enabling, by the retail financing module of the processing subsystem, the buyer to repay the funds to the financier with interest using the one or more currencies based on the perpetual/futures contract generated for managing the retail chain finance in step 560. In some embodiment, enabling the buyer to repay the funds to the financier with interest using the one or more currencies may include enabling the buyer to repay the funds using two options, such as one is paying it back with Fiat plus interest and other is through cryptocurrencies with interest also with the one or more cryptocurrencies.

In a specific embodiment, the method 500 further includes receiving by the retail finance module, one or more inputs associated with repayment process of the funds from the borrower, wherein the one or more inputs includes a decision associated with depositing the funds using fiat currency, a decision associated with depositing the funds using cryptocurrency, a decision associated with depositing the funds using fungible tokens, a risk mitigation strategy and payback terms. In one embodiment, receiving the one or more inputs associated with the repayment process of the funds from the borrower may include receiving the one or more inputs with a decision associated with depositing the funds using the fungible tokens as an alternate way to make payments and transact in the network where investors could subscribe to the tokens released by the company.

Various embodiments of the present disclosure provides a hybrid model in which Fiat and cryptocurrencies are used to serve the funding needs of business enterprises. The system happens initially within on-chain and a second stage would happen outside the chain as the borrowers would take it outside the crypto system to deploy it in their businesses.

Moreover, the present disclosed system offers distinct advantages to all participants. While suppliers gain quicker access to money they are owed, buyers get more time to pay off their balances. On either side of the equation, the parties can use the cash on hand for other projects to keep their respective operations running smoothly.

Moreover, the present disclosed system offers distinct advantages to all participants. While borrowers gain quicker access to money they are owed and get more time to pay off their balances. On either side of the equation, the parties can use the crypto assets, stable currencies on hand for other projects to keep their respective operations running smoothly.

Furthermore, the present disclosed system adds financial feature to its range of products for the benefit and convenience of its customers. The SCF will add strength in financing supply chain partners through an online platform for providing funding support to supply chain partners of renowned and established corporate enterprises. Therefore, the system offers hassle-free paperless online banking service, customization as per business requirements is possible and the online platform is integrated with corporate enterprise resource planning software.

Furthermore, the present disclosed system adds financial feature to its range of products for the benefit and convenience of its customers. The retail finance adds strength in financing retail finance protocol partners through an online platform for providing funding support to retail finance protocol partners of individuals, traders, renowned and established corporate enterprises. Therefore, the system offers hassle-free paperless online banking service, customization as per business requirements is possible and the online platform is integrated with individual and corporate enterprise resource planning software.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for managing supply chain finance comprising:
a processing subsystem hosted on a server and configured to execute on a network to control bidirectional communications among a plurality of modules comprising:
a finance request receiving module configured to:
receive one or more invoices corresponding to one or more supplied goods or one or more provided services from a supplier; and
receive a request for process of raising funds from a buyer for the one or more supplied goods or the one or more provided services based on the one or more invoices received from the supplier;
a financier seeking module operatively coupled to the finance request receiving module, wherein the financier seeking module is configured to identify a financier for financing the funds to the buyer based on the request received, wherein the funds corresponding to each of the one or more supplied goods or the one or more provided services is raised by the supplier;
a supply chain financing module operatively coupled to the financier seeking module, wherein the supply chain financing module is configured to:
generate a perpetual contract between the buyer and the financier to mitigate the currency volatility risk for financing the funds upon identification of the financier;
enable the financier in financing the funds with one or more currencies to the buyer for paying the supplier for each of the one or more supplied goods or the one or more provided services based on the perpetual contract generated; and
enable the buyer to repay the funds to the financier with interest using the one or more currencies based on the perpetual contract generated for managing the supply chain finance.

2. The system as claimed in claim 1, wherein the processing subsystem comprises a user verification module configured to verify the supplier for obtaining the funds using a know your customer verification process.

3. The system as claimed in claim 1, wherein the one or more invoices presented by the supplier are scanned using scanners and are converted into non-fungible tokens.

4. The system as claimed in claim 1, wherein the one or more currencies comprises a cryptocurrency and fiat currency.

5. The system as claimed in claim 4, wherein the cryptocurrency comprises at least one of a Bitcoin, an Ethereum, a Dogecoin or a combination thereof.

6. The system as claimed in claim 1, wherein the supply chain financing module is configured to receive one or more inputs associated with repayment process of the funds from the buyer, wherein the one or more inputs comprises a decision associated with depositing the funds using fiat currency, a decision associated with depositing the funds using cryptocurrency, a decision associated with depositing the funds using fungible tokens used to transact in the network, a risk mitigation strategy and payback terms.

7. The system as claimed in claim 1, wherein the financier comprises at least one of a lending financial institution, a person or a combination thereof.

8. The system as claimed in claim 1, wherein the processing subsystem comprises a blockchain based platform for managing trading of supply chain finance.

9. A system for managing retail finance comprising:
a retail processing subsystem hosted on a server and configured to execute on a network to control bidirectional communications among a plurality of modules comprising:
a finance request receiving module configured to:
receive one or more borrowing or borrowers request corresponding to one or more crypto collaterals or one or more collateralized crypto assets from a borrower; and
receive a request for process of raising funds from a borrower for the one or more crypto collaterals or the one or more collateralized crypto assets based on the one or more borrowing or borrower request received from the borrower;
a financier seeking module operatively coupled to the finance request receiving module, wherein the financier seeking module is configured to identify a financier for financing the funds to the borrower based on the request received, wherein the funds corresponding to each of the one or more crypto collaterals or the one or more provided collateralized crypto assets is raised by the borrower;
a retail financing module operatively coupled to the financier seeking module, wherein the retail financing module is configured to:
generate a perpetual contract to mitigate the currency volatility risk between the buyer and the financier for financing the funds upon identification of the financier;
enable the financier in financing the funds with one or more currencies to the borrower for paying the borrower for each of the one or more crypto collaterals or the one or more collateralized crypto assets based on the perpetual contract generated; and
enable the borrower to repay the funds to the financier with interest using the one or more currencies based on the perpetual contract generated for managing the retail finance.

10. The system as claimed in claim 1, wherein the retail processing subsystem comprises a blockchain based platform for managing trading in retail finance.

11. The system as claimed in claim 1, wherein the one or more crypto collaterals presented by the borrowers are incorporated into smart contracts and are converted into non-fungible tokens.

12. The system as claimed in claim 1, wherein the retail financing module is configured to receive one or more inputs associated with repayment process of the funds from the borrower, wherein the one or more inputs comprises a decision associated with depositing the funds using fiat currency, a decision associated with depositing the funds using cryptocurrency, a decision associated with depositing the funds using fungible tokens used to transact in the network, a risk mitigation strategy and payback terms.

13. A method comprising:
receiving, by a finance request receiving module of a processing subsystem, one or more invoices corresponding to one or more supplied goods or one or more provided services from a supplier;
receiving, by the finance request receiving module of the processing subsystem, a request for process of raising funds from a buyer for the one or more supplied goods or the one or more provided services based on the one or more invoices received from the supplier;
identifying, by a financier seeking module of the processing subsystem, a financier for financing the funds to the buyer based on the request received, wherein the funds corresponding to each of the one or more supplied goods or the one or more provided services is raised by the supplier;
generating, by a supply chain financing module of the processing subsystem, a perpetual contract between the buyer and the financier for financing the funds upon identification of the financier;
enabling, by the supply chain financing module of the processing subsystem, the financier in financing the funds with one or more currencies to the buyer for paying the supplier for each of the one or more supplied goods or the one or more provided services based on the perpetual contract generated; and
enabling, by the supply chain financing module of the processing subsystem, the buyer to repay the funds to the financier with interest using the one or more currencies based on the perpetual contract generated for managing the supply chain finance.

14. A method for managing retail finance comprising:
receiving, by a retail finance request receiving module of a processing subsystem, one or more crypto collaterals corresponding to one or more collateralized crypto assets or one or more borrowing requests from a borrower;
receiving, by the retail finance request receiving module of the processing subsystem, a request for process of raising funds from a borrower for the one or more crypto collaterals or the one or more collateralized crypto assets based on the one or more borrowing requests from the borrower;
identifying, by a retail financier seeking module of the processing subsystem, a financier for financing the funds to the borrower based on the request received, wherein the funds corresponding to each of the one or more crypto collaterals or the one or more borrowing requests is raised by the borrower;
generating, by a retail financing module of the processing subsystem, a perpetual contract to mitigate the currency volatility risk between the borrower and the financier for financing the funds upon identification of the financier;
enabling, by the retail financing module of the processing subsystem, the financier in financing the funds with one or more currencies to the borrower for paying the borrowed requests for each of the one or more crypto collaterals or the one or more collateralized crypto assets based on the perpetual contract generated; and
enabling, by the retail financing module of the processing subsystem, the borrower to repay the funds to the financier with interest using the one or more currencies based on the perpetual contract generated to mitigate the currency volatility risk for managing the retail finance.
